(19) United States
(12) Patent Application Publication
(10) Pub. No.: US 2011/0158320 A1
(43) Pub. Date: Jun. 30, 2011

(54) METHODS AND APPARATUS FOR PREDICTION REFINEMENT USING IMPLICIT MOTION PREDICTIONS

(76) Inventors: Yunfei Zheng, Plainsboro, NJ (US); Oscar Divorra Escoda, Barcelona (ES); Peng Yin, Ithaca, NY (US); Joel Sole, Plainsboro, NJ (US)

(21) Appl. No.: 12/737,945

(22) PCT Filed: Sep. 1, 2009
(86) PCT No.: PCT/US09/04948

§ 371 Date: Mar. 2, 2011

Related U.S. Application Data
(60) Provisional application No. 61/094,295, filed on Sep. 4, 2008.

(51) Int. Cl. H04N 7/26

(52) U.S. Cl. 375/240.16; 375/E07.125

(57) ABSTRACT

Methods and apparatus are provided for prediction refinement using implicit motion prediction. An apparatus includes an encoder for encoding an image block using explicit motion prediction to generate a coarse prediction for the image block and using implicit motion prediction to refine the coarse prediction.

### CROSS-REFERENCE TO RELATED APPLICATIONS

This application claims the benefit of U.S. Provisional Application Ser. No. 61/094,295, filed 4 Sep., 2008, which is incorporated by reference herein in its entirety.

### TECHNICAL FIELD

The present principles relate generally to video encoding and decoding and, more particularly, to methods and apparatus for prediction refinement using implicit motion prediction.

### BACKGROUND

Most existing video coding standards exploit the presence of temporal redundancy by block-based motion compensation. An example of such a standard is the International Organization for Standardization/International Electrotechnical Commission (ISO/IEC) Moving Picture Experts Group-4 (MPEG-4) Part 10 Advanced Video Coding (AVC) standard/International Telecommunication Union, Telecommunication Sector (ITU-T) H.264 Recommendation (hereinafter the “MPEG-4 AVC Standard”).

Such block-based motion compensation that exploits the presence of temporal redundancy may be considered to be a type of forward motion prediction, in which a prediction signal is obtained by explicitly sending side information, namely motion information. To minimize overhead so as not to outweigh the advantage of the motion compensation (MC), a coarse motion field (block-based) is often used. Backward motion prediction, such as the well-known Least-square Prediction (LSP), can avoid the necessity of transmitting motion vectors. However, the resulting prediction performance is highly dependent on the model parameters settings (e.g., the topology of the filter support and the training window). In the LSP method, the model parameters are desired to be adapted to local motion characteristics. Herein, “forward motion prediction” is used synonymously (interchangeably) with “explicit motion prediction”. Similarly, “backward motion prediction” is used synonymously (interchangeably) with “implicit motion prediction”.

### Inter-Prediction

In video coding, inter-prediction is extensively employed to reduce temporal redundancy between the target frame and reference frames. Motion estimation/compensation is the key component in inter-prediction. In general, we can classify motion models and their corresponding motion estimation techniques into two categories. The first category is forward prediction, which is based on the explicit motion representation (motion vector). The motion vector will be explicitly transmitted in this approach. The second category is backward prediction, in which motion information is not explicitly represented by a motion vector but is instead exploited in an implicit fashion. In backward prediction, no motion vector is transmitted but temporal redundancy can also be exploited at a corresponding decoder.

Turning to FIG. 1, an exemplary forward motion estimation scheme involving block matching is indicated generally by the reference numeral 100. The forward motion estimation scheme 100 involves a reconstructed reference frame 110 having a search region 101 and a prediction 102 within the search region 101. The forward motion estimation scheme 100 also involves a current frame 150 having a target block 151 and a reconstructed region 152. A motion vector Mv is used to denote the motion between the target block 151 and the prediction 102.

The forward prediction approach 100 corresponds to the first category mentioned above, and is well known and adopted in current video coding standards such as, for example, the MPEG-4 AVC Standard. The first category is usually performed in two steps. The motion vectors between the target (current) block 151 and the reference frames (e.g., 110) are estimated. Then the motion information (motion vector Mv) is coded and explicitly sent to the decoder. At the decoder, the motion information is decoded and used to predict the target block 151 from previously decoded reconstructed reference frames.

The second category refers to the class of prediction methods that do not code motion information explicitly in the bitstream. Instead, the same motion information derivation is performed at the decoder as is performed at the encoder. One practical backward prediction scheme is to use a kind of localized spatial-temporal auto-regressive model, where least-square prediction (LSP) is applied. Another approach is to use a patch-based approach, such as a template matching prediction scheme. Turning to FIG. 2, an exemplary backward motion estimation scheme involving template matching prediction (TMP) is indicated generally by the reference numeral 200. The backward motion estimation scheme 200 involves a reconstructed reference frame 210 having a search region 211, a prediction 212 within the search region 211, and a neighborhood 213 with respect to the prediction 212. The backward motion estimation scheme 200 also involves a current frame 250 having a target block 251, a template 252 with respect to the target block 251, and a reconstructed region 253.

In general, the performance of forward prediction is highly dependent on the predicting block size and the amount of overhead transmitted. When the block size is reduced, the cost of overhead for each block will increase, which limits the forward prediction to be only good at predicting smooth and rigid motion. In backward prediction, since no overhead is transmitted, the block size can be reduced without incurring additional overhead. Thus, backward prediction is more suitable for complicated motions, such as deformable motion.

### MPEG-4 AVC Standard Inter-Prediction

The MPEG-4 AVC Standard uses tree-structured hierarchical macroblock partitions. Inter-coded 16×16 pixel macroblocks may be broken into macroblock partitions of sizes 16×8, 8×16, or 8×8. Macroblock partitions of 8×8 pixels are also known as sub-macroblocks. Sub-macroblocks may also be broken into sub-macroblock partitions of sizes 8×4, 4×8, and 4×4. An encoder may select how to divide a particular macroblock into partitions and sub-macroblock partitions based on the characteristics of the particular macroblock, in order to maximize compression efficiency and subjective quality.

Multiple reference pictures may be used for inter-prediction, with a reference picture index coded to indicate which of the multiple reference pictures is used. In P pictures (or P slices), only single directional prediction is used, and the allowable reference pictures are managed in list 0. In B pictures (or B slices), two lists of reference pictures are managed, list 0 and list 1. In B pictures (or B slices), single directional prediction using either list 0 or list 1 is allowed, or bi-prediction using both list 0 and list 1 is allowed. When bi-prediction is used, the list 0 and the list 1 predictors are averaged together to form a final predictor.

Each macroblock partition may have an independent reference picture index, a prediction type (list 0, list 1, or bi-prediction), and an independent motion vector. Each sub-macroblock partition may have independent motion vectors, but all sub-macroblock partitions in the same sub-macroblock use the same reference picture index and prediction type.

In the MPEG-4 AVC Joint Model (JM) Reference Software, a Rate-Distortion Optimization (RDO) framework is used for mode decision. For inter modes, motion estimation is separately considered from mode decision. Motion estimation is first performed for all block types of inter modes, and then the mode decision is made by comparing the cost of each inter mode and intra mode. The mode with the minimal cost is selected as the best mode.

For P-frames, the following modes may be selected:

$$MODE ∈ \{ \begin{matrix}INTRA 4 \times 4 , INTRA 16 \times 16 , SKIP , \\ 16 \times 16 , 16 \times 8 , 8 \times 16 , 8 \times 8 , 8 \times 4 , 4 \times 8 , 4 \times 4\end{matrix} \}$$

For B-frames, the following modes may be selected:

$$MODE ∈ \{ \begin{matrix}INTRA 4 \times 4 , INTRA 16 \times 16 , DIRECT , FWD 16 \times 16 , \\ FWD 16 \times 8 , FWD 8 \times 16 , FWD 8 \times 8 , FWD 8 \times 4 , \\ FWD 4 \times 8 , FWD 4 \times 4 , BAK 16 \times 16 , BAK 16 \times 8 , BAK 8 \times 16 , \\ BAK 8 \times 8 , BAK 8 \times 4 , BAK 4 \times 8 , BAK 4 \times 4 , BI 16 \times 16 , \\ BI 16 \times 8 , BI 8 \times 16 , BI 8 \times 8 , BI 8 \times 4 , BI 4 \times 8 , BI 4 \times 4\end{matrix} \} ,$$

However, while current block-based standards provide predictions that increase the compression efficiency of such standards, prediction refinement is desired in order to further increase the compression efficiency, particularly under varying conditions.

### SUMMARY

These and other drawbacks and disadvantages of the prior art are addressed by the present principles, which are directed to methods and apparatus for prediction refinement using implicit motion prediction.

According to an aspect of the present principles, there is provided an apparatus. The apparatus includes an encoder for encoding an image block using explicit motion prediction to generate a coarse prediction for the image block and using implicit motion prediction to refine the coarse prediction.

According to another aspect of the present principles, there is provided an encoder for encoding an image block. The encoder includes a motion estimator for performing explicit motion prediction to generate a coarse prediction for the image block. The encoder also includes a prediction refiner for performing implicit motion prediction to refine the coarse prediction.

According to yet another aspect of the present principles, there is provided in a video encoder, a method for encoding an image block. The method includes generating a coarse prediction for the image block using explicit motion prediction. The method also includes refining the coarse prediction using implicit motion prediction.

According to still another aspect of the present principles, there is provided an apparatus. The apparatus includes a decoder for decoding an image block by receiving a coarse prediction for the image block generated using explicit motion prediction and refining the coarse prediction using implicit motion prediction.

According to a further aspect of the present principles, there is provided a decoder for decoding an image block. The decoder includes a motion compensator for receiving a coarse prediction for the image block generated using explicit motion prediction and refining the coarse prediction using implicit motion prediction.

According to a still further aspect of the present principles, there is provided in a video decoder, a method for decoding an image block. The method includes receiving a coarse prediction for the image block generated using explicit motion prediction. The method also includes refining the coarse prediction using implicit motion prediction.

These and other aspects, features and advantages of the present principles will become apparent from the following detailed description of exemplary embodiments, which is to be read in connection with the accompanying drawings.

### BRIEF DESCRIPTION OF THE DRAWINGS

The present principles may be better understood in accordance with the following exemplary figures, in which:

FIG. 1 is a block diagram showing an exemplary forward motion estimation scheme involving block matching;

FIG. 2 is a block diagram showing an exemplary backward motion estimation scheme involving template matching prediction (TMP);

FIG. 3 is a block diagram showing an exemplary backward motion estimation scheme using least-square prediction;

FIG. 4 is a block diagram showing an example of block-based least-square prediction;

FIG. 5 is a block diagram showing an exemplary video encoder to which the present principles may be applied, in accordance with an embodiment of the present principles;

FIG. 6 is a block diagram showing an exemplary video decoder to which the present principles may be applied, in accordance with an embodiment of the present principles;

FIGS. 7A and 7B are block diagrams showing an example of a pixel based least-square prediction for prediction refinement, in accordance with an embodiment of the present principles;

FIG. 8 is a block diagram showing an example of a block-based least-square prediction for prediction refinement, in accordance with an embodiment of the present principles;

FIG. 9 is a flow diagram showing an exemplary method for encoding video data for an image block using prediction refinement with least-square prediction, in accordance with an embodiment of the present principles; and

FIG. 10 is a flow diagram showing an exemplary method for decoding video data for an image block using prediction refinement with least-square prediction, in accordance with an embodiment of the present principles.

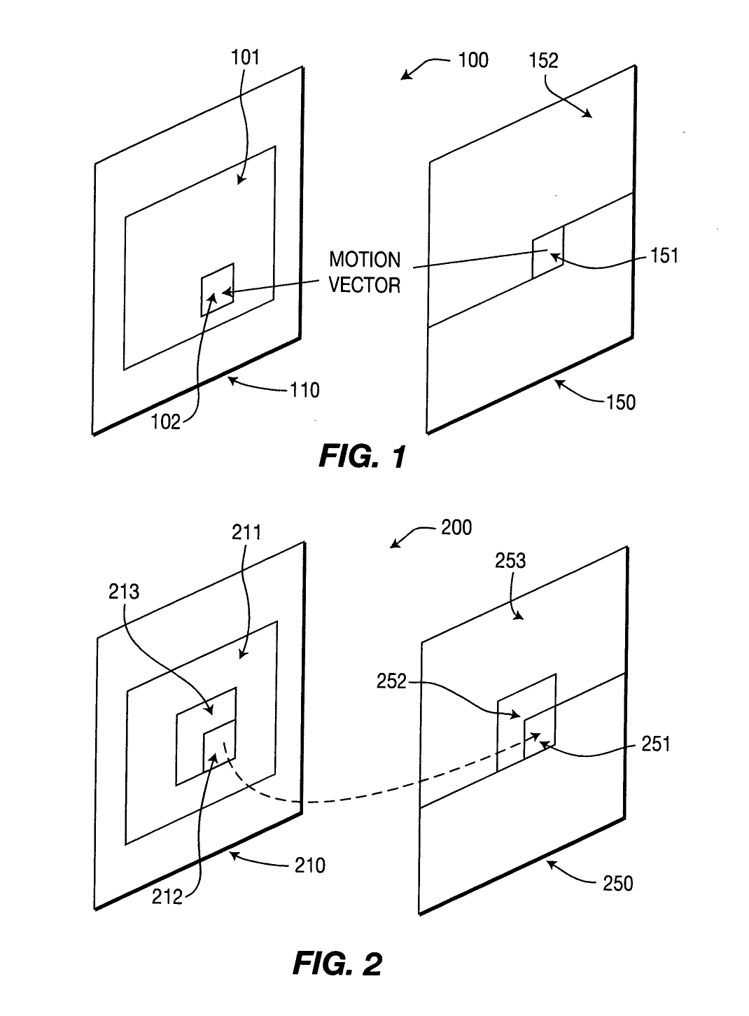

### DETAILED DESCRIPTION

The present principles are directed to methods and apparatus for prediction refinement using implicit motion prediction.

The present description illustrates the present principles. It will thus be appreciated that those skilled in the art will be able to devise various arrangements that, although not explicitly described or shown herein, embody the present principles and are included within its spirit and scope.

All examples and conditional language recited herein are intended for pedagogical purposes to aid the reader in understanding the present principles and the concepts contributed by the inventor(s) to furthering the art, and are to be construed as being without limitation to such specifically recited examples and conditions.

Moreover, all statements herein reciting principles, aspects, and embodiments of the present principles, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagrams presented herein represent conceptual views of illustrative circuitry embodying the present principles. Similarly, it will be appreciated that any flow charts, flow diagrams, state transition diagrams, pseudocode, and the like represent various processes which may be substantially represented in computer readable media and so executed by a computer or processor, whether or not such computer or processor is explicitly shown.

The functions of the various elements shown in the figures may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (“DSP”) hardware, read-only memory (“ROM”) for storing software, random access memory (“RAM”), and non-volatile storage.

Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

In the claims hereof, any element expressed as a means for performing a specified function is intended to encompass any way of performing that function including, for example, a) a combination of circuit elements that performs that function or b) software in any form, including, therefore, firmware, microcode or the like, combined with appropriate circuitry for executing that software to perform the function. The present principles as defined by such claims reside in the fact that the functionalities provided by the various recited means are combined and brought together in the manner which the claims call for. It is thus regarded that any means that can provide those functionalities are equivalent to those shown herein.

Reference in the specification to “one embodiment” or “an embodiment” of the present principles, as well as other variations thereof, means that a particular feature, structure, characteristic, and so forth described in connection with the embodiment is included in at least one embodiment of the present principles. Thus, the appearances of the phrase “in one embodiment” or “in an embodiment”, as well any other variations, appearing in various places throughout the specification are not necessarily all referring to the same embodiment.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

As used herein, the phrase “image block” refers to any of a macroblock, a macroblock partition, a sub-macroblock, and a sub-macroblock partition.

As noted above, the present principles are directed to methods and apparatus for prediction refinement using implicit motion prediction. In accordance with the present principles, video prediction techniques are proposed which combine forward (motion compensation) and backward (e.g., least-square prediction (LSP)) prediction approaches to take advantage of both explicit and implicit motion representations.

Accordingly, a description of least-square prediction, followed by a description of prediction refinement with least-square prediction, will herein after be provided.

### Least-Square Prediction

Least-square prediction (LSP) is a backward direction based approach to predict the target block or pixel, which exploits the motion information in an implicit fashion and is not required to send any motion vectors as overhead to a corresponding decoder.

In further detail, LSP formulates the prediction as a spatio-temporal auto-regression problem, that is, the intensity value of the target pixel can be estimated by the linear combination of its spatio-temporal neighbors. The regression coefficients, which implicitly carry the local motion information, can be estimated by localized learning within a spatio-temporal training window. The spatio-temporal auto-regression model and the localized learning operate as follows.

Let us use X(x, y, t) to denote a discrete video source, where (x, y)ε[1,W]×[1,H] are spatial coordinates and tε[1,T] is the frame index. For simplicity, we denote the position of a pixel in spatio-temporal space by a vector \vec{n}₀=(x, y, t), and the position of its spatio-temporal neighbors by \vec{n}ᵢ, i=1, 2, . . . , N (the number of pixels in the spatio-temporal neighborhood N is the order of our model).

Spatio-Temporal Auto-Regression Model

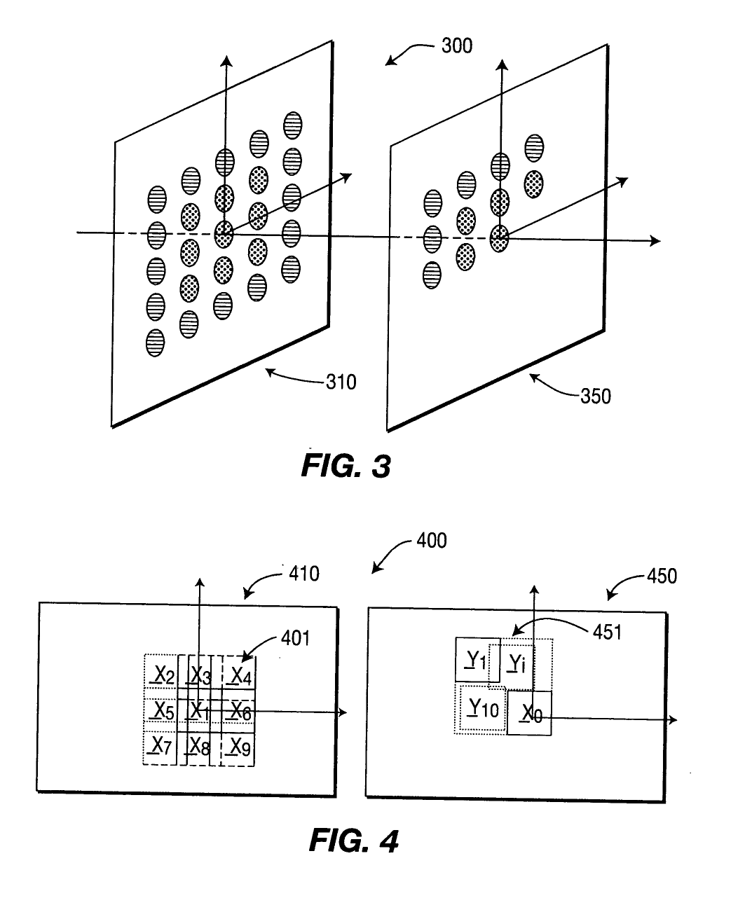

In LSP, the intensity value of the target pixel is formulated as the linear combination of its neighboring pixels. Turning to FIG. 3, an exemplary backward motion estimation scheme using least-square prediction is indicated generally by the reference numeral 300. The target pixel X is indicated by an oval having a diagonal hatch pattern. The backward motion estimation scheme 300 involves a K frame 310 and a K-1 frame 350. The neighboring pixels Xi of target pixel X are indicated by ovals having a cross hatch pattern. The training data Yi is indicated by ovals having a horizontal hatch pattern and ovals having a cross hatch pattern. The auto-regression model pertaining to the example of FIG. 3 is as follows:

$$\hat{X} ( {{n}^{->}}_{0} ) = {\sum }_{i = l}^{N} {a}_{k} X ( {{n}^{->}}_{k} ) \qquad ( 1 )$$

where \hat{X} is the estimation of the target pixel X, and \vec{a}={aᵢ}ᵢ₌₁^{N} are the combination coefficients. The topology of the neighbor (filter support) can be flexible to incorporate both spatial and temporal reconstructed pixels. FIG. 3 shows an example for one kind of neighbor definition, which includes 9 temporal collocated pixels (in the K-1 frame) and 4 spatial causal neighboring pixels (in the K frame).

Spatio-Temporal Localized Learning

Based on the non-stationary of video source, we argue that \vec{a} should be adaptively updated within the spatio-temporal space instead of being assumed homogeneous over all of the video signal. One way of adapting \vec{a} is to follow Wiener's classical idea of minimizing the mean square error (MSE) within a local spatio-temporal training window M as follows:

$$\begin{matrix}M S E = {\sum }_{{{n}^{->}}_{0} ∈ M} {[ X ( {{n}^{->}}_{0} ) - \hat{X} ( {{n}^{->}}_{0} ) ]}^{2} \\ = {\sum }_{{{n}^{->}}_{0} ∈ M} {[ X ( {{n}^{->}}_{0} ) - {\sum }_{k = 1}^{N} {a}_{k} X ( {{n}^{->}}_{k} ) ]}^{2}\end{matrix} \qquad ( 2 )$$

Suppose there are M samples in the training window. We can write all of the training samples into an M×1 vector \vec{y}. If we put the N neighbors for each training sample into a 1×N row vector, then all of the training samples generate a data matrix C with a size of M×N. The derivation of local optimal filter coefficients \vec{a} is formulated into the following least-square problem:

\vec{a}=arg min MSE=arg min∥\vec{y}_{M×1}−C_{M×N}\vec{a}_{N×1}∥² (3)

When the training window size M is larger than the filter support size N, the above problem is over determined and admits to the following close-form solution:

\vec{a}=(C^{T}C)⁻¹C^{T}\vec{y} (4)

Although the above theory is pixel based, least-square prediction can be very easily extended to block-based prediction. Let us use X₀ to denote the target block to be predicted, and {Xᵢ}ᵢ₌₁^{N} to be the neighboring overlapped blocks as shown in FIG. 4. Turning to FIG. 4, an example of block-based least-square prediction is indicated generally by the reference numeral 400. The block-based least-square prediction 400 involves a reference frame 410 having neighboring blocks 401, and a current frame 450 having training blocks 451. The neighboring blocks 401 are also indicated by reference numerals X₁ through X₉. The target block is indicated by reference numeral X0. The training blocks 451 are indicated by reference numerals Yᵢ, Y₁, and Y₁₀.

Then the block-based regression will be as follows:

$$\hat{X} ( {{n}^{->}}_{0} ) = {\sum }_{i = 1}^{N} {a}_{k} {X}_{i} \qquad ( 5 )$$

The neighboring blocks and training blocks are defined as in FIG. 4. In such a case, it is easy to derive the similar solution of the coefficients like in Equation (4).

Motion Adaptation

The modeling capability of Equation (1) or Equation (5) relies heavily on the choice of the filter support and the training window. For capturing motion information in video, the topology of the filter support and the training window should adapt to the motion characteristics in both space and time. Due to the non-stationary nature of motion information in a video signal, adaptive selection of the filter support and the training window is desirable. For example, in a slow motion area, the filter support and training window shown in FIG. 3 are sufficient. However, this kind of topology is not suitable for capturing fast motion, because the samples in the collocated training window could have different motion characteristics, which makes the localized learning fail. In general, the filter support and training window should be aligned with the motion trajectory orientation.

Two solutions can be used to realize the motion adaptation. One is to obtain a layered representation of the video signal based on motion segmentation. In each layer, a fixed topology of the filter support and training window can be used since all the samples within a layer share the same motion characteristics. However, such adaptation strategy inevitably involves motion segmentation, which is another challenging problem.

Another solution is to exploit a spatio-temporal resampling and empirical Bayesian fusion techniques to realize the motion adaptation. Resampling produces a redundant representation of video signals with distributed spatio-temporal characteristics, which includes a lot of generated resamples. In each resample, applying the above least-square prediction model with a fixed topology of the filter support and the training window can obtain a regression result. The final prediction is the fusion of all the regression results from the resample set. This approach can obtain very good prediction performance. However, the cost is the extremely high complexity incurred by applying least-square prediction for each resample, which limits the application of least-square prediction for practical video compression.

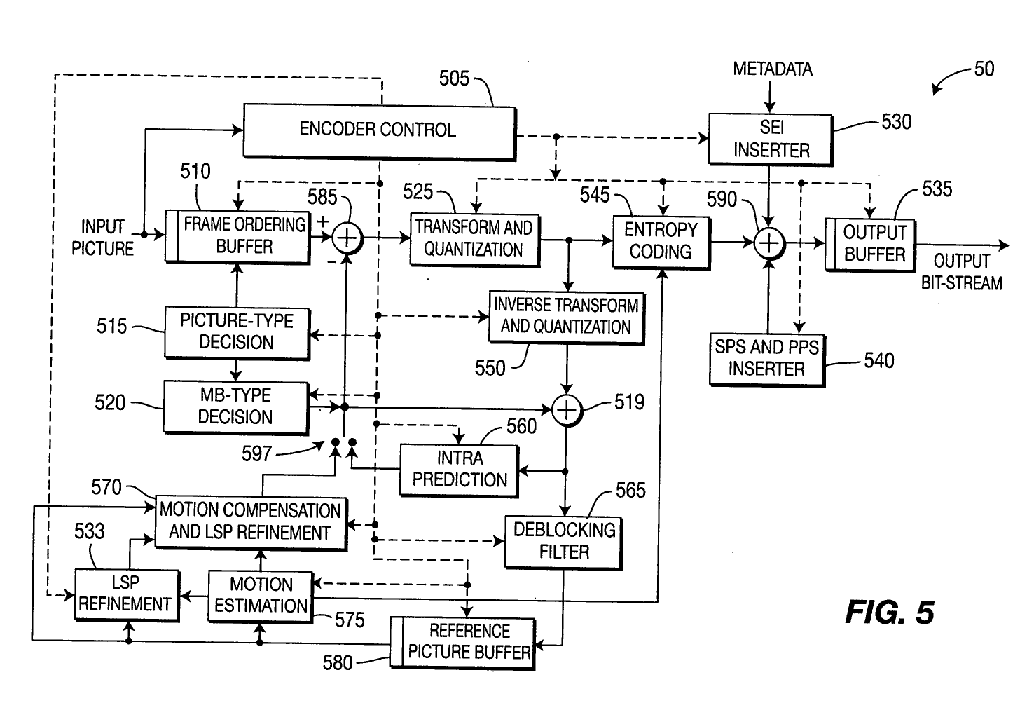

Turning to FIG. 5, an exemplary video encoder to which the present principles may be applied is indicated generally by the reference numeral 500. The video encoder 500 includes a frame ordering buffer 510 having an output in signal communication with a non-inverting input of a combiner 585. An output of the combiner 585 is connected in signal communication with a first input of a transformer and quantizer 525. An output of the transformer and quantizer 525 is connected in signal communication with a first input of an entropy coder 545 and a first input of an inverse transformer and inverse quantizer 550. An output of the entropy coder 545 is connected in signal communication with a first non-inverting input of a combiner 590. An output of the combiner 590 is connected in signal communication with a first input of an output buffer 535.

A first output of an encoder controller 505 is connected in signal communication with a second input of the frame ordering buffer 510, a second input of the inverse transformer and inverse quantizer 550, an input of a picture-type decision module 515, an input of a macroblock-type (MB-type) decision module 520, a second input of an intra prediction module 560, a second input of a deblocking filter 565, a first input of a motion compensator (with LSP refinement) 570, a first input of a motion estimator 575, and a second input of a reference picture buffer 580. A second output of the encoder controller 505 is connected in signal communication with a first input of a Supplemental Enhancement Information (SEI) inserter 530, a second input of the transformer and quantizer 525, a second input of the entropy coder 545, a second input of the output buffer 535, and an input of the Sequence Parameter Set (SPS) and Picture Parameter Set (PPS) inserter 540. A third output of the encoder controller 505 is connected in signal communication with a first input of a least-square prediction module 533.

A first output of the picture-type decision module 515 is connected in signal communication with a third input of a frame ordering buffer 510. A second output of the picture-type decision module 515 is connected in signal communication with a second input of a macroblock-type decision module 520.

An output of the Sequence Parameter Set (SPS) and Picture Parameter Set (PPS) inserter 540 is connected in signal communication with a third non-inverting input of the combiner 590.

An output of the inverse quantizer and inverse transformer 550 is connected in signal communication with a first non-inverting input of a combiner 519. An output of the combiner 519 is connected in signal communication with a first input of the intra prediction module 560 and a first input of the deblocking filter 565. An output of the deblocking filter 565 is connected in signal communication with a first input of a reference picture buffer 580. An output of the reference picture buffer 580 is connected in signal communication with a second input of the motion estimator 575, a second input of the least-square prediction refinement module 533, and a third input of the motion compensator 570. A first output of the motion estimator 575 is connected in signal communication with a second input of the motion compensator 570. A second output of the motion estimator 575 is connected in signal communication with a third input of the entropy coder 545. A third output of the motion estimator 575 is connected in signal communication with a third input of the least-square prediction module 533. An output of the least-square prediction module 533 is connected in signal communication with a fourth input of the motion compensator 570.

An output of the motion compensator 570 is connected in signal communication with a first input of a switch 597. An output of the intra prediction module 560 is connected in signal communication with a second input of the switch 597. An output of the macroblock-type decision module 520 is connected in signal communication with a third input of the switch 597. The third input of the switch 597 determines whether or not the “data” input of the switch (as compared to the control input, i.e., the third input) is to be provided by the motion compensator 570 or the intra prediction module 560. The output of the switch 597 is connected in signal communication with a second non-inverting input of the combiner 519 and with an inverting input of the combiner 585.

Inputs of the frame ordering buffer 510 and the encoder controller 505 are available as input of the encoder 500, for receiving an input picture. Moreover, an input of the Supplemental Enhancement Information (SEI) inserter 530 is available as an input of the encoder 500, for receiving metadata. An output of the output buffer 535 is available as an output of the encoder 500, for outputting a bitstream.

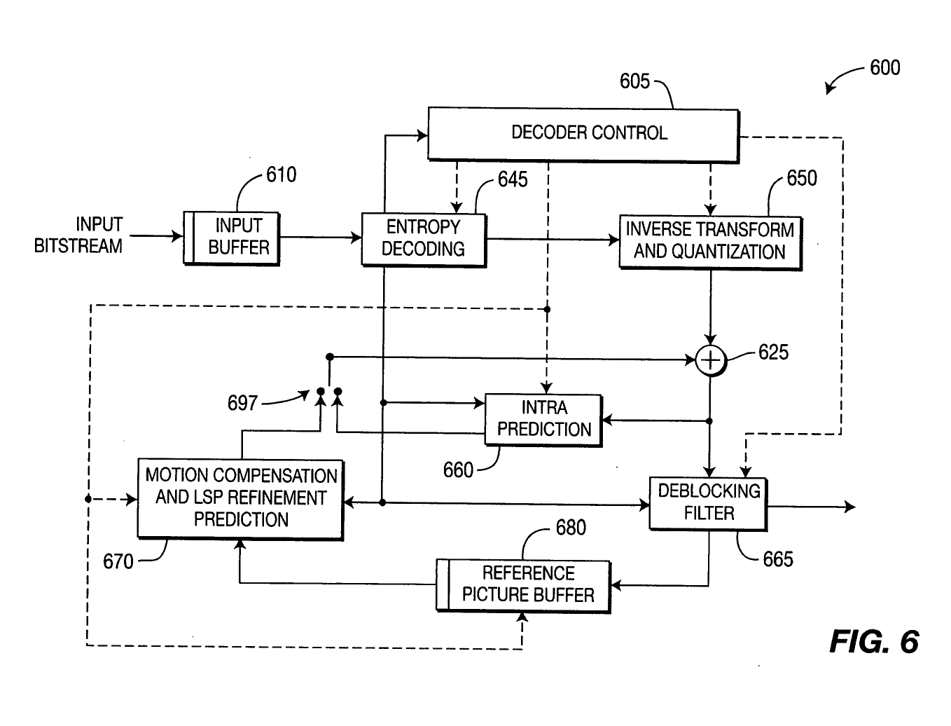

Turning to FIG. 6, an exemplary video decoder to which the present principles may be applied is indicated generally by the reference numeral 600.

The video decoder 600 includes an input buffer 610 having an output connected in signal communication with a first input of the entropy decoder 645. A first output of the entropy decoder 645 is connected in signal communication with a first input of an inverse transformer and inverse quantizer 650. An output of the inverse transformer and inverse quantizer 650 is connected in signal communication with a second non-inverting input of a combiner 625. An output of the combiner 625 is connected in signal communication with a second input of a deblocking filter 665 and a first input of an intra prediction module 660. A second output of the deblocking filter 665 is connected in signal communication with a first input of a reference picture buffer 680. An output of the reference picture buffer 680 is connected in signal communication with a second input of a motion compensator and LSP refinement predictor 670.

A second output of the entropy decoder 645 is connected in signal communication with a third input of the motion compensator and LSP refinement predictor 670 and a first input of the deblocking filter 665. A third output of the entropy decoder 645 is connected in signal communication with an input of a decoder controller 605. A first output of the decoder controller 605 is connected in signal communication with a second input of the entropy decoder 645. A second output of the decoder controller 605 is connected in signal communication with a second input of the inverse transformer and inverse quantizer 650. A third output of the decoder controller 605 is connected in signal communication with a third input of the deblocking filter 665. A fourth output of the decoder controller 605 is connected in signal communication with a second input of the intra prediction module 660, with a first input of the motion compensator and LSP refinement predictor 670, and with a second input of the reference picture buffer 680.

An output of the motion compensator and LSP refinement predictor 670 is connected in signal communication with a first input of a switch 697. An output of the intra prediction module 660 is connected in signal communication with a second input of the switch 697. An output of the switch 697 is connected in signal communication with a first non-inverting input of the combiner 625.

An input of the input buffer 610 is available as an input of the decoder 600, for receiving an input bitstream. A first output of the deblocking filter 665 is available as an output of the decoder 600, for outputting an output picture.

As noted above, in accordance with the present principles, video prediction techniques are proposed which combine forward (motion compensation) and backward (LSP) prediction approaches to take advantage of both explicit and implicit motion representations. In particular, use of the proposed schemes involves explicitly sending some information to capture the coarse motion, and then LSP is used to refine the motion prediction through the coarse motion. This can be seen as a joint approach between backward prediction with LSP and forward motion prediction. Advantageous of the present principles include reducing the bitrate overhead and improving the prediction quality for forward motion, as well as improving the precision of LSP, thus improving the coding efficiency. Although disclosed and described herein with respect to an inter-prediction context, given the teachings of the present principles provided herein, one of ordinary skill in this and related arts will readily be able to extend the present principles to intra-prediction, while maintaining the spirit of the present principles.

Prediction Refinement with LSP

Least-square prediction is used to realize motion adaptation, which requires capturing the motion trajectory at each location. Although we can exploit the least-square prediction for the backward adaptive video coding method, to solve this problem, the complexity incurred by this approach is demanding for practical applications. To achieve motion adaptation with some reasonable complexity cost, we exploit the motion estimation result as side information to describe the motion trajectory which can help least-square prediction to set up the filter support and training window.

In an embodiment, we perform the motion estimation first, and then perform LSP. The filter support and training window is set up based on the output motion vector of the motion estimation. Thus, the LSP works as a refinement step for the original forward motion compensation. The filter support is capable of being flexible to incorporate both spatial and/or temporal neighboring reconstructed pixels. The temporal neighbors are not limited within the reference picture to which the motion vector points. The same motion vector or scaled motion vector based on the distance between the reference picture and the current picture can be used for other reference pictures. In this manner, we take advantage of both forward prediction and backward LSP to improve the compression efficiency.

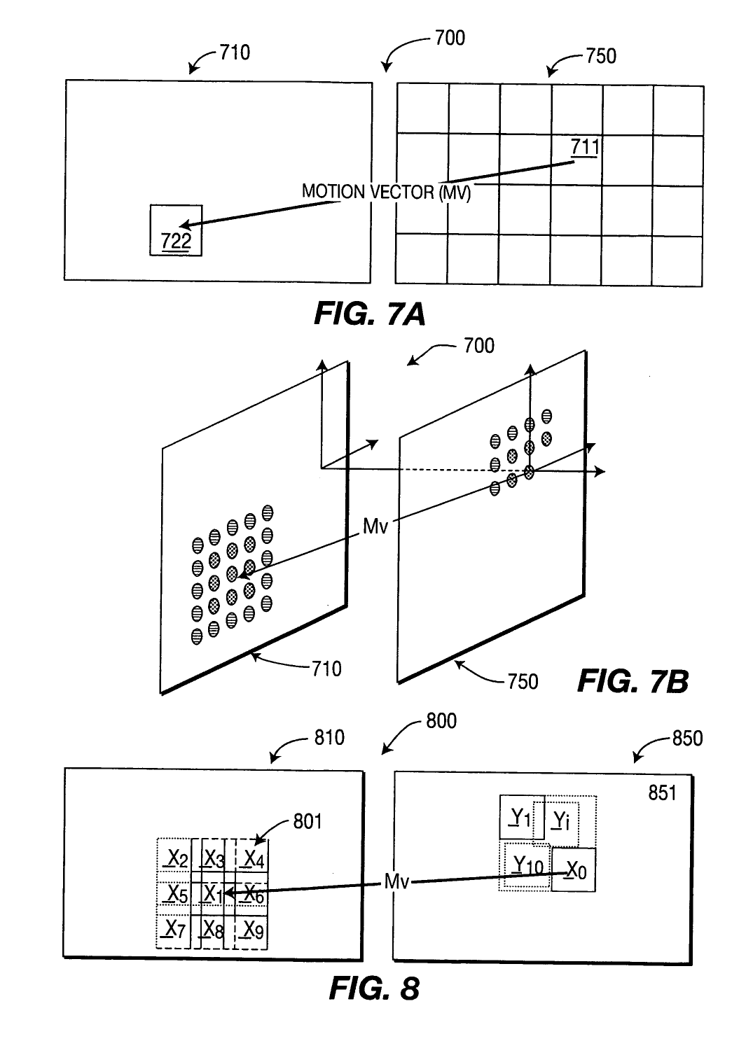

Turning to FIGS. 7A and 7B, an example of a pixel based least-square prediction for prediction refinement is indicated generally by the reference numeral 700. The pixel based least-square prediction for prediction refinement 700 involves a K frame 710 and a K-1 frame 750. Specifically, as shown in FIGS. 7A and 7B, the motion vector (Mv) for a target block 722 can be derived from the motion vector predictor or motion estimation, such as that performed with respect to the MPEG-4 AVC Standard. Then using this motion vector Mv, we set up the filter support and training window for LSP along the orientation that is directed by the motion vector. We can do pixel or block-based LSP inside the predicting block 711. The MPEG-4 AVC Standard supports tree-structured based hierarchical macroblock partitions. In one embodiment, LSP refinement is applied to all partitions. In another embodiment, LSP refinement is applied to larger partitions only, such as 16×16. If block-based LSP is performed on the predicting block, then the block-size of LSP does not need to be the same as that of the prediction block.

Next we describe an exemplary embodiment which includes the principles of the present invention. In this embodiment, we put forth an approach where the forward motion estimation is first done at each partition. Then we conduct LSP for each partition to refine the prediction result. We will use the MPEG-4 AVC Standard as a reference to describe our algorithms, although as would be apparent to those of ordinary skill in this and related arts, the teachings of the present principles may be readily applied to other coding standards, recommendations, and so forth.

### Embodiment

### Explicit Motion Estimation and LSP Refinement

In this embodiment, the explicit motion estimation is done first to get motion vector Mv for the predicting block or partition. Then pixel based LSP is conducted (here we describe our approach by using pixel-based LSP for simplicity, but it is easy to extend to block-based LSP). We define the filter support and training window for each pixel based on the motion vector Mv. Turning to FIG. 8, an example of a block-based least-square prediction for prediction refinement is indicated generally by the reference numeral 800. The block-based least-square prediction for prediction refinement 800 involves a reference frame 810 having neighboring blocks 801, and a current frame 850 having training blocks 851. The neighboring blocks 401 are also indicated by reference numerals X₁ through X₉. The target block is indicated by reference numeral X0. The training blocks 451 are indicated by reference numerals Yᵢ, Y₁, and Y₁₀. As shown in FIGS. 7A and 7B or FIG. 8, we can define the filter support and training window along the direction of the motion vector Mv. The filter support and training window can cover both spatial and temporal pixels. The prediction value of the pixel in the predicting block will be refined pixel by pixel. After all pixels inside the predicting block are refined, the final prediction can be selected among the prediction candidates with/without LSP refinement or their fused version based on the rate distortion (RD) cost. Finally, we set the LSP indicator lsp_idc to signal the selection as follows:

If lsp_idc is equal to 0, select the prediction without LSP refinement.

If lsp_idc is equal to 1, select the prediction with LSP refinement.

If lsp_idc is equal to 2, select the fused prediction version of with and without LSP refinement. The fusion scheme can be any linear or nonlinear combination of the previous two predictions. To avoid increasing much more overhead for the final selection, the lsp_idc can be designed at macro-block level.

### Impact on Other Coding Blocks

With respect to the impact on other coding blocks, a description will now be given regarding the motion vector for least-squared prediction in accordance with various embodiments of the present principles. In the MPEG-4 AVC Standard, the motion vector for the current block is predicted from the neighboring block. Thus, the value of the motion vector of the current block will affect the future neighboring blocks. This raises a question of the LSP refined block regarding what motion vector we should use. In the first embodiment, since the forward motion estimation is done at each partition level, we can retrieve the motion vector for the LSP refined block. In the second embodiment, we can use the macro-block level motion vector for all LSP refined blocks inside the macro-block.

With respect to the impact on other coding blocks, a description will now be given regarding using a deblocking filter in accordance with various embodiments of the present principles. For the deblocking filter, in the first embodiment, we can treat LSP refined block the same as forward motion estimation block, and use the motion vector for LSP refinement above. Then the deblocking process is not changed. In the second embodiment, since LSP refinement has different characteristic than the forward motion estimation block, we can adjust the boundary strength, the filter type and filter length accordingly.

TABLE 1 shows slice header syntax in accordance with an embodiment of the present principles.

TABLE 1

| slice_header( ) { | C | Descriptor |
|---|---|---|
| first_mb_in_slice | 2 | ue(v) |
| slice_type | 2 | ue(v) |
| pic_parameter_set_id | 2 | ue(v) |
| . . . | | |
| if (slice_type != I) | | |
| lsp_enable_flag | 2 | u(1) |
| . . . | | |

Semantics of the lsp_enable_flag syntax element of TABLE 1 are as follows:

lsp_enable_flag equal to 1 specifies that LSP refinement prediction is enabled for the slice. lsp_enable_flag equal to 0 specifies that LSP refinement prediction is not enabled for the slice.

TABLE 2 shows macroblock layer syntax in accordance with an embodiment of the present principles.

TABLE 2

| macroblock_layer( ) { | C | Descriptor |
|---|---|---|
| mb_type | 2 | ue(v)\|ae(v) |
| if( MbPartPredMode( mb_type, 0 ) != Intra_4×4 && | | |
| MbPartPredMode( mb_type, 0 ) ! = Intra_8×8 && | | |
| MbPartPredMode( mb_type, 0 ) ! = Intra_16×16 ) | | |
| lsp_idc | 2 | u(2) |
| . . . . . | | |

Semantics of the lsp_idc syntax element of TABLE 2 are as follows:

lsp_idc equal to 0 specifies that the prediction is not refined by LSP refinement. lsp_idc equal to 1 specifies that the prediction is the refined version by LSP. lsp_idc equals to 2 specifies that the prediction is the combination of the prediction candidates with and without LSP refinement.

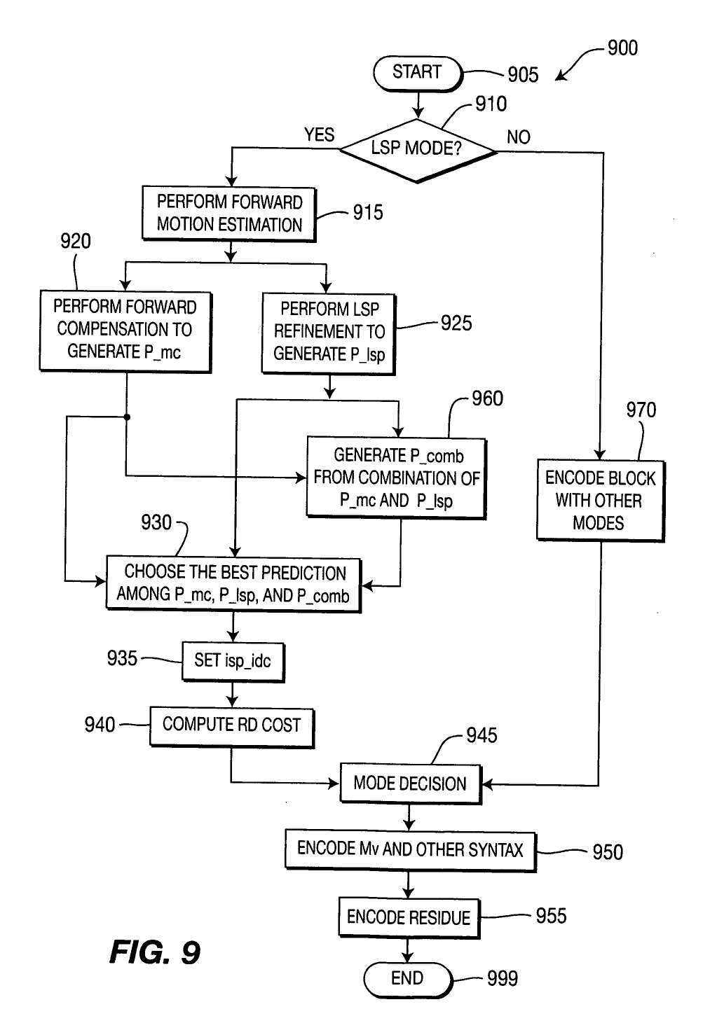

Turning to FIG. 9, an exemplary method for encoding video data for an image block using prediction refinement with least-square prediction is indicated generally by the reference numeral 900. The method 900 includes a start block 905 that passes control to a decision block 910. The decision block 910 determines whether or not the current mode is least-square prediction mode. If so, then control is passed to a function block 915. Otherwise, control is passed to a function block 970.

The function block 915 performs forward motion estimation, and passes control to a function block 920 and a function block 925. The function block 920 performs motion compensation to obtain a prediction P_mc, and passes control to a function block 930 and a function block 960. The function block 925 performs least-square prediction refinement to generate a refined prediction P_lsp, and passes control to a function block 930 and the function block 960. The function block 960 generates a combined prediction P_comb from a combination of the prediction P_mc and the prediction P_lsp, and passes control to the function block 930. The function block 930 chooses the best prediction among P_mc, P_lsp, and P_comb, and passes control to a function block 935. The function block 935 sets Isp_idc, and passes control to a function block 940. The function block 940 computes the rate distortion (RD) cost, and passes control to a function block 945. The function block 945 performs a mode decision for the image block, and passes control to a function block 950. The function block 950 encodes the motion vector and other syntax for the image block, and passes control to a function block 955. The function block 955 encodes the residue for the image block, and passes control to an end block 999. The function block 970 encode the image block with other modes (i.e., other than LSP mode), and passes control to the function block 945.

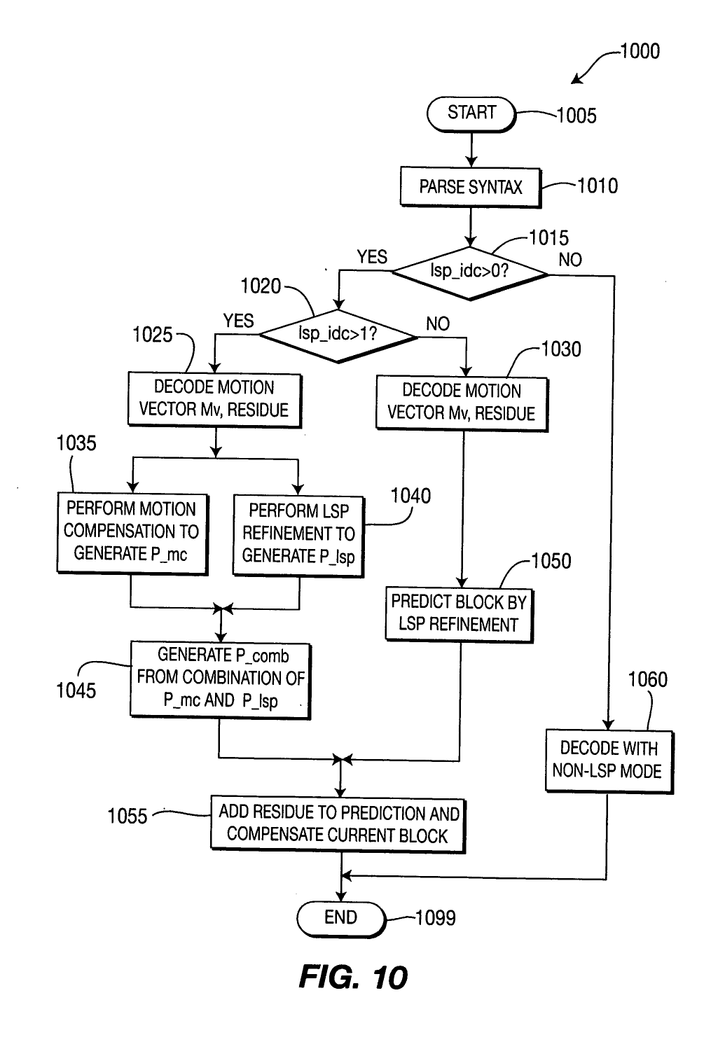

Turning to FIG. 10, an exemplary method for decoding video data for an image block using prediction refinement with least-square prediction is indicated generally by the reference numeral 1000. The method 1000 includes a start block 1005 that passes control to a function block 1010. The function block 1010 parses syntax, and passes control to a decision block 1015. The decision block 1015 determines whether or not Isp_idc>0. If so, then control is passed to a function block 1020. Otherwise, control is passed to a function block 1060. The function block 1020 determines whether or not Isp_idc>1. If so, then control is passed to a function block 1025. Otherwise, control is passed to a function block 1030. The function block 1025 decodes the motion vector Mv and the residue, and passes control to a function block 1035 and a function block 1040. The function block 1035 performs motion compensation to generate a prediction P_mc, and passes control to a function block 1045. The function block 1040 performs least-square prediction refinement to generate a prediction P_lsp, and passes control to the function block 1045. The function block 1045 generates a combined prediction P_comb from a combination of the prediction P_mc and the prediction P_lsp, and passes control to the function block 1055. The function block 1055 adds the residue to the prediction, compensates to the current block, and passes control to an end block 1099.

The function block 1060 decodes the image block with a non-LSP mode, and passes control to the end block 1099.

The function block 1030 decodes the motion vector (Mv) and residue, and passes control to a function block 1050. The function block 1050 predicts the block by LSP refinement, and passes control to the function block 1055.

A description will now be given of some of the many attendant advantages/features of the present invention, some of which have been mentioned above. For example, one advantage/feature is an apparatus having an encoder for encoding an image block using explicit motion prediction to generate a coarse prediction for the image block and using implicit motion prediction to refine the coarse prediction.

Another advantage/feature is the apparatus having the encoder as described above, wherein the coarse prediction is any of an intra prediction and an inter prediction.

Yet another advantage/feature is the apparatus having the encoder as described above, wherein the implicit motion prediction is least-square prediction.

Moreover, another advantage/feature is the apparatus having the encoder wherein the implicit motion prediction is least-square prediction as described above, and wherein a least-square prediction filter support and a least-square prediction training window cover both spatial and temporal pixels relating to the image block.

Further, another advantage/feature is the apparatus having the encoder wherein the implicit motion prediction is least-square prediction as described above, and wherein the least-square prediction can be pixel-based or block-based, and is used in single-hypothesis motion compensation prediction or multiple-hypothesis motion compensation prediction.

Also, another advantage/feature is the apparatus having the encoder wherein the least-square prediction can be pixel-based or block-based, and is used in single-hypothesis motion compensation prediction or multiple-hypothesis motion compensation prediction as described above, and wherein least-square prediction parameters for the least square prediction are defined based on forward motion estimation.

Additionally, another advantage/feature is the apparatus having the encoder wherein least-square prediction parameters for the least square prediction are defined based on forward motion estimation as described above, wherein temporal filter support for the least-square prediction can be conducted with respect to one or more reference pictures, or with respect to one or more reference picture lists.

Moreover, another advantage/feature is the apparatus having the encoder wherein the least-square prediction can be pixel-based or block-based, and is used in single-hypothesis motion compensation prediction or multiple-hypothesis motion compensation prediction as described above, and wherein a size of the block based least-square prediction is different from a forward motion estimation block size.

Further, another advantage/feature is the apparatus having the encoder wherein the least-square prediction can be pixel-based or block-based, and is used in single-hypothesis motion compensation prediction or multiple-hypothesis motion compensation prediction as described above, and wherein motion information for the least-square prediction can be derived or estimated by a motion vector predictor.

These and other features and advantages of the present principles may be readily ascertained by one of ordinary skill in the pertinent art based on the teachings herein. It is to be understood that the teachings of the present principles may be implemented in various forms of hardware, software, firmware, special purpose processors, or combinations thereof.

Most preferably, the teachings of the present principles are implemented as a combination of hardware and software. Moreover, the software may be implemented as an application program tangibly embodied on a program storage unit. The application program may be uploaded to, and executed by, a machine comprising any suitable architecture. Preferably, the machine is implemented on a computer platform having hardware such as one or more central processing units (“CPU”), a random access memory (“RAM”), and input/output (“I/O”) interfaces. The computer platform may also include an operating system and microinstruction code. The various processes and functions described herein may be either part of the microinstruction code or part of the application program, or any combination thereof, which may be executed by a CPU. In addition, various other peripheral units may be connected to the computer platform such as an additional data storage unit and a printing unit.

It is to be further understood that, because some of the constituent system components and methods depicted in the accompanying drawings are preferably implemented in software, the actual connections between the system components or the process function blocks may differ depending upon the manner in which the present principles are programmed. Given the teachings herein, one of ordinary skill in the pertinent art will be able to contemplate these and similar implementations or configurations of the present principles.

Although the illustrative embodiments have been described herein with reference to the accompanying drawings, it is to be understood that the present principles is not limited to those precise embodiments, and that various changes and modifications may be effected therein by one of ordinary skill in the pertinent art without departing from the scope or spirit of the present principles. All such changes and modifications are intended to be included within the scope of the present principles as set forth in the appended claims.

1. An apparatus, comprising:
an encoder for encoding an image block using explicit motion prediction to generate a coarse prediction for the image block and using implicit motion prediction to refine the coarse prediction.

2. The apparatus of claim 1, wherein the coarse prediction is any of an intra prediction and an inter prediction.

3. The apparatus of claim 1, wherein the implicit motion prediction is least-square prediction.

4. The apparatus of claim 3, wherein a least-square prediction filter support and a least-square prediction training window cover both spatial and temporal pixels relating to the image block.

5. The apparatus of claim 3, wherein the least-square prediction can be pixel-based or block-based, and is used in single-hypothesis motion compensation prediction or multiple-hypothesis motion compensation prediction.

6. The apparatus of claim 5, wherein least-square prediction parameters for the least square prediction are defined based on forward motion estimation.

7. The apparatus of claim 6, wherein temporal filter support for the least-square prediction can be conducted with respect to one or more reference pictures, or with respect to one or more reference picture lists.

8. The apparatus of claim 5, wherein a size of the block based least-square prediction is different from a forward motion estimation block size.

9. The apparatus of claim 5, wherein motion information for the least-square prediction can be derived or estimated by a motion vector predictor.

10. An encoder for encoding an image block, comprising:
a motion estimator for performing explicit motion prediction to generate a coarse prediction for the image block; and
a prediction refiner for performing implicit motion prediction to refine the coarse prediction.

11. The encoder of claim 10, wherein the coarse prediction is any of an intra prediction and an inter prediction.

12. The encoder of claim 10, wherein the implicit motion prediction is least-square prediction.

13. In a video encoder, a method for encoding an image block, comprising:
generating a coarse prediction for the image block using explicit motion prediction; and
refining the coarse prediction using implicit motion prediction.

14. The method of claim 13, wherein the coarse prediction is any of an intra prediction and an inter prediction.

15. The method of claim 13, wherein the implicit motion prediction is least-square prediction.

16. The method of claim 15, wherein a least-square prediction filter support and a least-square prediction training window cover both spatial and temporal pixels relating to the image block.

17. The method of claim 15, wherein the least-square prediction can be pixel-based or block-based, and is used in single-hypothesis motion compensation prediction or multiple-hypothesis motion compensation prediction.

18. The method of claim 17, wherein least-square prediction parameters for the least square prediction are defined based on forward motion estimation.

19. The method of claim 18, wherein temporal filter support for the least-square prediction can be conducted with respect to one or more reference pictures, or with respect to one or more reference picture lists.

20. The method of claim 17, wherein a size of the block based least-square prediction is different from a forward motion estimation block size.

21. The method of claim 17, wherein motion information for the least-square prediction can be derived or estimated by a motion vector predictor.

22. An apparatus, comprising:
a decoder for decoding an image block by receiving a coarse prediction for the image block generated using explicit motion prediction and refining the coarse prediction using implicit motion prediction.

23. The apparatus of claim 22, wherein the coarse prediction is any of an intra prediction and an inter prediction.

24. The apparatus of claim 22, wherein the implicit motion prediction is least-square prediction.

25. The apparatus of claim 24, wherein a least-square prediction filter support and a least-square prediction training window cover both spatial and temporal pixels relating to the image block.

26. The apparatus of claim 24, wherein the least-square prediction can be pixel-based or block-based, and is used in single-hypothesis motion compensation prediction or multiple-hypothesis motion compensation prediction.

27. The apparatus of claim 26, wherein least-square prediction parameters for the least square prediction are defined based on forward motion estimation.

28. The apparatus of claim 27, wherein temporal filter support for the least-square prediction can be conducted with respect to one or more reference pictures, or with respect to one or more reference picture lists.

29. The apparatus of claim 26, wherein a size of the block based least-square prediction is different from a forward motion estimation block size.

30. The apparatus of claim 26, wherein motion information for the least-square prediction can be derived or estimated by a motion vector predictor.

31. A decoder for decoding an image block, comprising:
a motion compensator for receiving a coarse prediction for the image block generated using explicit motion prediction and refining the coarse prediction using implicit motion prediction.

32. The decoder of claim 31, wherein the coarse prediction is any of an intra prediction and an inter prediction.

33. The decoder of claim 31, wherein the implicit motion prediction is least-square prediction.

34. In a video decoder, a method for decoding an image block, comprising:
receiving a coarse prediction for the image block generated using explicit motion prediction; and
refining the coarse prediction using implicit motion prediction.

35. The method of claim 34, wherein the coarse prediction is any of an intra prediction and an inter prediction.

36. The method of claim 34, wherein the implicit motion prediction is least-square prediction.

37. The method of claim 36, wherein a least-square prediction filter support and a least-square prediction training window cover both spatial and temporal pixels relating to the image block.

38. The method of claim 36, wherein the least-square prediction can be pixel-based or block-based, and is used in single-hypothesis motion compensation prediction or multiple-hypothesis motion compensation prediction.

39. The method of claim 38, wherein least-square prediction parameters for the least square prediction are defined based on forward motion estimation.

40. The method of claim 39, wherein temporal filter support for the least-square prediction can be conducted with respect to one or more reference pictures, or with respect to one or more reference picture lists.

41. The method of claim 38, wherein a size of the block based least-square prediction is different from a forward motion estimation block size.

42. The method of claim 38, wherein motion information for the least-square prediction can be derived or estimated by a motion vector predictor.
